(19) United States
(12) Patent Application Publication
(10) Pub. No.: US 2021/0170774 A1
(43) Pub. Date: Jun. 10, 2021

(54) GRAVURE PRINTING PLATE AND GRAVURE PRINTING DEVICE USING THEREOF

(71) Applicant: SAMSUNG ELECTRO-MECHANICS CO., LTD., Suwon-si (KR)

(72) Inventors: Seung Jun KIM, Suwon-si (KR); Seung Ho LEE, Suwon-si (KR); Yong Hoon HEO, Suwon-si (KR)

(21) Appl. No.: 17/077,219

(22) Filed: Oct. 22, 2020

(30) Foreign Application Priority Data
Dec. 6, 2019 (KR) 10-2019-0161731

(51) Int. Cl. B41M 1/10; B41F 1/46; B41F 3/36

(52) U.S. Cl. CPC B41M 1/10; B41P 2217/50; B41F 3/36; B41F 1/46

(57) ABSTRACT

A gravure printing plate includes a convex portion and two or more polygonal cells partitioned by the convex portion, and including at least one protruding portion disposed at an edge of each of the at least two polygonal cells and extending toward a central portion of the corresponding cell therefrom.

### CROSS-REFERENCE TO RELATED APPLICATION(S)

This application claims the benefit of priority to Korean Patent Application No. 10-2019-0161731 filed on Dec. 6, 2019 in the Korean Intellectual Property Office, the disclosure of which is incorporated herein by reference in its entirety.

### TECHNICAL FIELD

The present disclosure relates to a gravure printing plate and a gravure printing device using the same.

### BACKGROUND

Gravure printing is a method of forming a printing pattern by engraving on a surface of a cylindrical metal roll, injecting ink into the pattern, and then transferring the pattern onto a surface of a printing object in a continuous paper form, wound in a roll form. Gravure printing has been widely used in photography, packaging and textile printing because it is much faster than conventional plate printing and has excellent printing quality. Recently, gravure printing has been applied to various processes within the IT and electronics industries, beyond an existing application field, thanks to excellent productivity thereof.

Meanwhile, a paste filled in a printing pattern of a gravure roller may be transferred to a printing sheet and subjected to a leveling process. In this case, there may be a problem in which leveling is completed with a state of having unevenness, rather than being leveled flat, due to interfacial tension of the paste. In addition, there may be a problem that printing roughness may be reduced because a printing pattern may be smeared or a sufficient amount of paste may not be transferred.

### SUMMARY

An aspect of the present disclosure is to provide a gravure printing plate and a gravure printing device having improved printing roughness.

Another aspect of the present disclosure is to provide a gravure printing plate and a gravure printing device having improved thickness distribution.

Another aspect of the present disclosure is to provide a gravure printing plate and a gravure printing device having improved breakdown voltage (BDV) characteristics.

An aspect of the present disclosure is to provide a gravure printing plate including a convex portion and at least two polygonal cells partitioned by the convex portion, and including at least one or more protruding portions disposed toward a central portion from an edge of the cell and a gravure printing device.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 is a schematic diagram illustrating a gravure printing system;

FIG. 2 is a schematic perspective view illustrating a gravure printing device used in FIG. 1;

FIG. 3 is a schematic diagram illustrating a chamber doctor of FIG. 2;

FIGS. 4 and 5 are schematic diagrams illustrating a printing process of FIG. 1;

FIG. 6 is a schematic diagram illustrating a gravure printing device according to another embodiment of the present disclosure;

FIG. 7 is a schematic plan view illustrating a gravure printing plate according to an embodiment of the present disclosure;

FIG. 8 is a schematic plan view illustrating a gravure printing plate according to another embodiment of the present disclosure;

FIG. 9 is a schematic plan view illustrating a gravure printing plate according to another embodiment of the present disclosure;

FIG. 10 is a schematic plan view illustrating a gravure printing plate according to another embodiment of the present disclosure;

FIG. 11 is an enlarged view of a cell of FIG. 8;

FIG. 12 is an enlarged view of a cell of FIG. 10;

FIG. 13 is a schematic cross-section view of a cell of FIG. 8;

FIGS. 14 and 15 are three-dimensional print-shape photographs in which a conductive paste is printed using a conventional gravure printing plate, and profile graphs in a vertical direction; and

FIGS. 16 and 17 are three-dimensional print-shaped photographs in which a conductive paste is printed using a gravure printing plate according to an embodiment of the present disclosure, and profile graphs in a vertical direction.

### DETAILED DESCRIPTION

Hereinafter, embodiments of the present disclosure will be described as follows with reference to the attached drawings. It is not intended to limit the techniques described herein to specific embodiments, and it should be understood as including various modifications, equivalents, and/or alternatives to the embodiments of the present disclosure. In connection with the description of the drawings, similar reference numerals may be used for similar components.

In the drawings, for clarity of description, parts irrelevant to the description may be omitted, and thicknesses of elements may be magnified to clearly represent layers and regions. Components having the same functions within a scope of the same idea may be described using the same reference numerals.

In the present specification, expressions such as “having”, “may have”, “include” or “may include” may indicate a presence of corresponding features (e.g., components such as numerical values, functions, operations, components, or the like), and may not exclude a presence of additional features.

In the present specification, expressions such as “A or B”, “at least one of A or/and B” or “one or more of A or/and B”, and the like, may include all possible combinations of items listed together. For example, “A or B”, or “at least one of A or B” may refer to all cases including (1) at least one A (2) at least one B, or (3) both at least one A and at least one B.

In the drawings, an X direction may be defined as a first direction, an L direction or a longitudinal direction, a Y direction may be defined as a second direction, a W direction or a width direction, and a Z direction may be defined as a third direction, a T direction or a thickness direction.

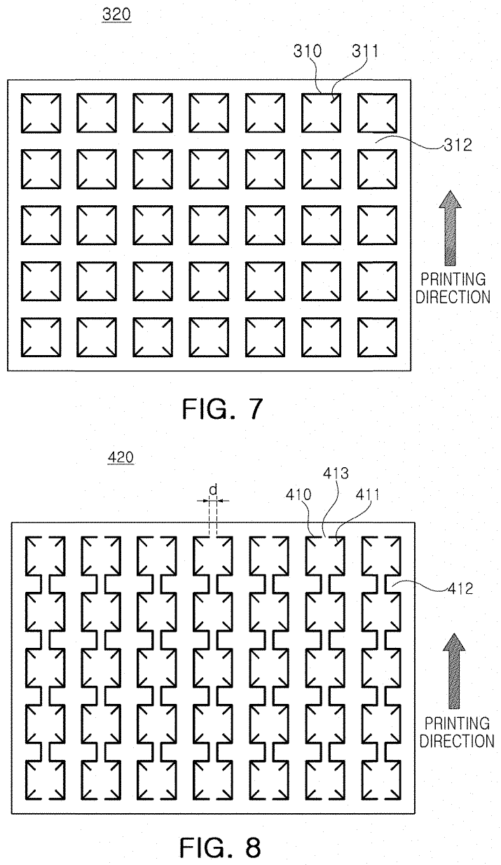

Hereinafter, a method of manufacturing a multilayer ceramic electronic component according to an embodiment of the present disclosure will be described in detail with reference to FIGS. 7 to 12. FIG. 7 is a schematic plan view illustrating a gravure printing plate according to an embodiment of the present disclosure.

Referring to FIG. 7, a gravure printing plate 320 according to an embodiment of the present disclosure may include a convex portion 312 and two or more polygonal cells 310 partitioned by the convex portion 312. In this case, at least one or more protruding portions 311 may be disposed inside the cell 310 from an edge of the cell 310 toward a central portion thereof.

In general, in the case of concave-plate printing such as gravure printing, there is a problem that it is difficult to obtain a printed material having high smoothness due to a difference in interfacial tension between a printing medium and an object to be printed and/or viscosity of the printing medium. In order to solve this problem, a method of increasing smoothness through a process in which a printing medium (paste) is transferred to an object to be printed and then leveled is used. However, in the process of transferring the printing medium filled in the cell, there may be a problem in which transferring is performed unevenly by the convex portion forming the cell, and a printing film is not completely flattened due to a lack of a transfer amount, resulting in a large print thickness distribution.

The gravure printing plate according to the present disclosure is aimed to resolve the above-described issues, it is possible to improve thickness distribution and increase printing quality, by placing a protruding portion 311 inside the cell 310 toward a central portion from an edge of the cell 310.

The gravure printing plate according to the present disclosure may include two or more polygonal cells 310 partitioned by the convex portion 312. In the present specification, the cell is partitioned by the convex portion, which may mean that cells are formed on both sides, based on one convex portion. Two or more cells 310 may be included, and the number of cells may be adjusted according to intended use.

An upper limit of the number of the cells is not particularly limited, but may be, for example, 100,000 or less.

The cells of the gravure printing plate according to the present disclosure may have a polygonal shape. The polygonal shape may mean a figure consisting of a finite line segment.

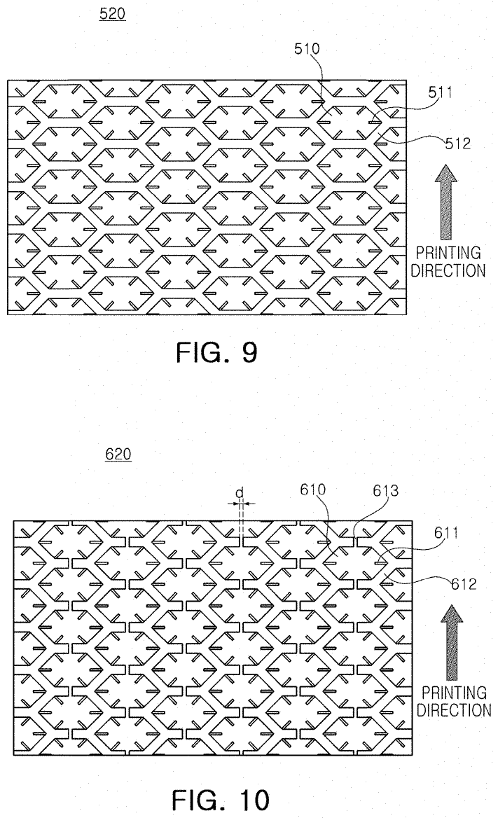

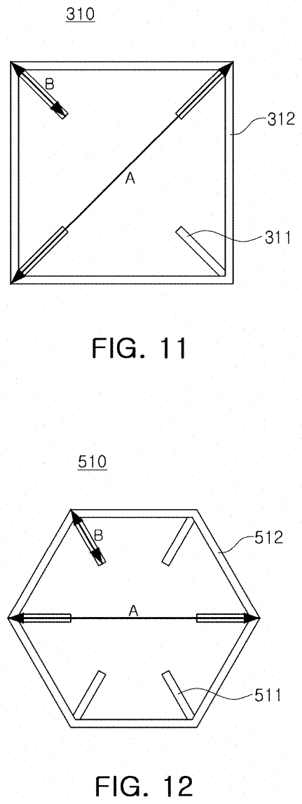

The line segment may mean a straight line, but may mean a line segment including a curved portion within an error range of, for example, ±10° as well as a straight line in a strict sense. Since the shape of the cell is formed by the convex portion partitioning the cell, the shape of the polygonal cell may be formed by a convex portion. In this case, the convex portion may be formed such that a plurality of convex portions form an angle of 180° or less, a lower limit of the angle formed by the plurality of convex portions is not particularly limited, for example, may exceed 0°. That is, the cell according to the present disclosure may have a form of a convex polygon. FIGS. 7 and 8 schematically illustrate a case in which a cell has a rectangular shape, and FIGS. 9 and 10 schematically illustrate a case in which a cell has a hexagonal shape. However, the shape of the cell of the gravure printing plate according to the present disclosure is not limited to a rectangle or a hexagon, and may have a triangular shape or a polygonal shape of an octagon or more.

In an embodiment of the present disclosure, a height of a convex portion 312 may be in a range of 5 μm to 30 μm. The height of the convex portion 312 may mean a depth of the cell 310 partitioned by the convex portion 312. When the height of the convex portion 312 is less than 5 μm, printing of printed matter corresponding to the cell 310 may not be easy. In addition, when the height of the convex portion 312 exceeds 30 μm, the thickness of the printed matter formed on the object to be printed may be thick, which may not facilitate thinning of a final product.

In one example, as shown in FIG. 13, a height h of a protruding portion included inside the cell according to the present disclosure may be less than or equal to a height H of a convex portion. When the height h of the protruding portion is the same as the height H of the convex portion, a printing medium may be evenly filled to the central portion of the cell due to the interfacial tension between a side surface of the protruding portion and the printing medium when gravure printing is performed with the gravure printing plate according to the present disclosure. In addition, when the height h of the protruding portion is smaller than the height H of the convex portion, the printing medium may be moved to a space between the protruding portion and the object to be printed during gravure printing with the gravure printing plate according to the present disclosure to improve printing roughness of the cell.

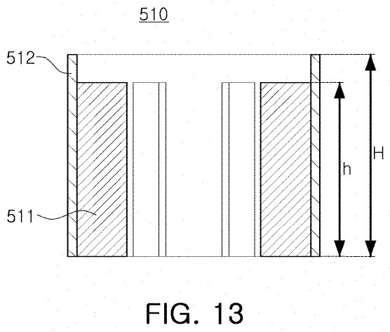

In an embodiment of the present disclosure, when a longest distance from any one edge of a cell of a gravure printing plate passing through a center of the cell to a convex portion opposing the edge is a length (A) of a cell, a ratio (B/A) of a length (B) of the protruding portion of the cell may be 0.167 or more. FIG. 11 is an enlarged view when a shape of a cell is rectangular, and FIG. 12 is an enlarged view when a shape of a cell is hexagonal. Referring to FIGS. 11 and 12, the longest distance (A) from any one edge of cells 310 and 510 passing through the center of the cell to the convex portion opposing to the edge may mean a length of the longest line among lines passing through the center of the cell. The ratio (B/A) may be 0.167 or more, 0.170 or more, 0.172 or more, or 0.175 or more, and an upper limit thereof is not particularly limited, but may be, for example, less than 0.5.

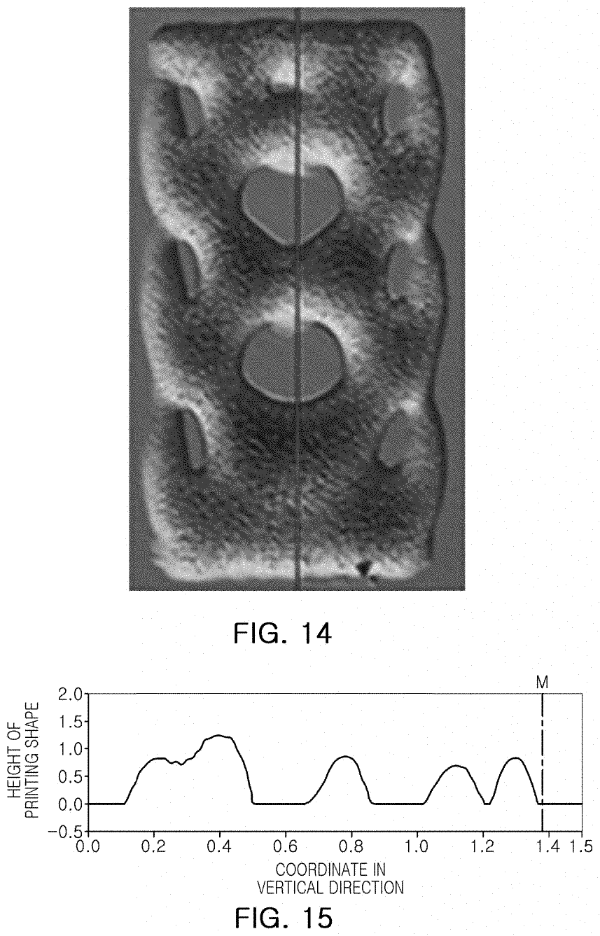

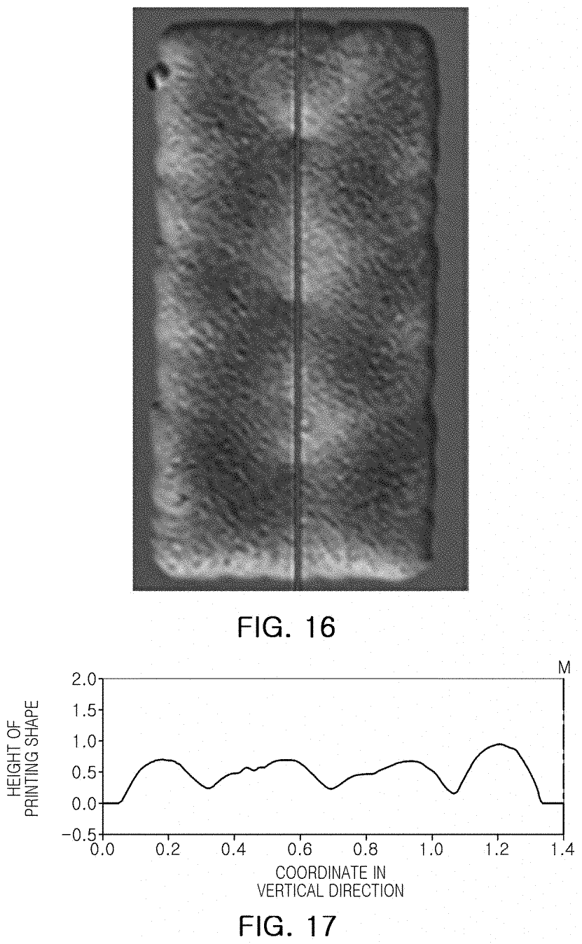

FIGS. 14 and 15 are three-dimensional print-shaped photographs in which a conductive paste is printed using a hexagonal conventional print cell and profile graphs in a vertical direction, and FIGS. 16 and 17 are three-dimensional print-shaped photographs in which a conductive paste is printed using the gravure printing plate according to the present disclosure and profile graphs in a vertical direction. The three-dimensional print-shaped image and the profile in the vertical direction were measured using a three-dimensional optical measuring device Nanospec (manufactured by Nanometrics),In FIGS. 16 and 17, a cell adjusted so that the ratio (B/A) of the length (B) of the protruding portion to the length (A) of the cell was 0.33. As can be confirmed through FIGS. 14 to 17, when the ratio (B/A) of the length (B) of the protruding portion to the length (A) of the cell of the gravure printing plate according to the present disclosure satisfies the range, it is possible to improve printing roughness, and to improve a transfer rate of a printing media.

In an example of the present disclosure, in the gravure printing plate according to the present disclosure, two or more protruding portions maybe disposed inside one cell. The number of protruding portions can be adjusted according to the shape of the cell, the type and viscosity of the printing medium. An upper limit of the number of the protruding portions is not particularly limited. But, for example, when the shape of the cell is n-square, the number of protruding portions may be n or less (where, n is a natural number). That is, one or more or two or more exemplary protruding portions of the present disclosure may be included in the cell, and may be disposed at all edges of the cell.

In an embodiment of the present disclosure, in the gravure printing plate according to the present disclosure, one side of the convex portions of the cell may be disposed to correspond to one side of the convex portion of another adjacent cell, the gravure printing plate may include a path disposed in the convex portion such that the cells are connected in the printing direction. FIG. 8 is a view illustrating an example in which a path is disposed in a convex portion of a rectangular cell, and FIG. 10 is a view illustrating an example in which a path is disposed in a convex portion of a hexagonal cell. Referring to FIGS. 8 and 10, in exemplary cells 420 and 620 according to the present disclosure, passages 413 and 613 may be disposed to convex portions 412 and 612 such that the cells 420 and 620 are connected in a direction, parallel to a printing direction. As described above, when the passages 413 and 613 are disposed on the convex portions 412 and 612 so that the cells 420 and 620 are connected, connectivity between the printing media printed after the transfer of the printed media may be improved and printing thickness distribution may be improved.

In one example, when the gravure printing plate of the present disclosure includes a path, a width (d) of the path may be in a range of 10 μm to 20 μm. When the width (d) of the path is less than 10 μm, an effect of improving the thickness distribution through the passage maybe insignificant, and when the width thereof exceeds 20 μm, the thickness distribution of the printing medium may increase.

The present disclosure also relates to a gravure printing device.

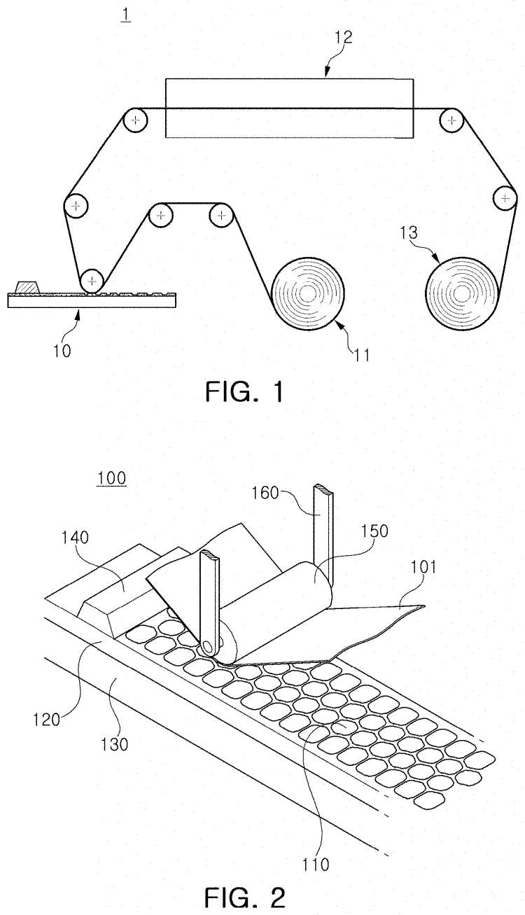

FIG. 1 is a schematic system of a gravure printing device according to an embodiment of the present disclosure. Referring to FIG. 1, the gravure printing device according to an embodiment of the present disclosure may include an unwinder 11, a printing device 10, a drying device 12 for drying a sheet on which a printing paste is transferred from the printing device 10, and a rewinder 13 for winding a sheet on which a printing pattern is formed.

The unwinder 11 and the rewinder 13 may be a partial configuration of a roll-to-roll facility, and as such, since a sheet is printed using the roll-to-roll facility, continuous printing may be performed. The roll-to-roll facility may be provided with a plurality of support rolls (not shown), and the plurality of support rolls may serve to support and move the sheet.

FIG. 2 is a schematic perspective view of a gravure printing device according to an embodiment of the present disclosure. Referring to FIG. 2, a gravure printing device 100 according to the present disclosure may include a gravure printing plate 120 provided with a plurality of cells 110 formed intaglio on a surface thereof, a chamber doctor 140 applying a printing paste to a surface of the gravure printing plate 120 and filling the plurality of cells 110 with the printing paste, and a pressing roll 150 pressing a sheet 101 provided on the gravure printing plate 120 in a roll-to-roll manner to contact the sheet 101 to the plurality of cells 110.

The gravure printing plate 120 is a plate on which a printing pattern is engraved. A gravure printing plate as described herein maybe used as the gravure printing plate 120. The material of the gravure printing plate 120 is not particularly limited, and may be, for example, a glass material, a nickel material, a resin material, a sus material, and the like, but is not limited thereto.

A fixing plate 130 may be disposed at a lower end of the gravure printing plate 120 as needed to suppress deformation of a pattern during printing, but is not limited thereto.

The chamber doctor 140 may apply a printing paste to the surface of the gravure printing plate 120, to fill the plurality of cells 110 with the printing paste. The chamber doctor 140 may be a sealed chamber doctor 140 in which the printing paste is disposed in a dispositional space therein, and in the case of using the sealed chamber doctor 140, the printing paste maybe used from low viscosity to high viscosity.

A printing paste may be disposed in the sealed chamber doctor 140. The specific form of the chamber doctor 140 is not particularly limited, and the material thereof is not particularly limited.

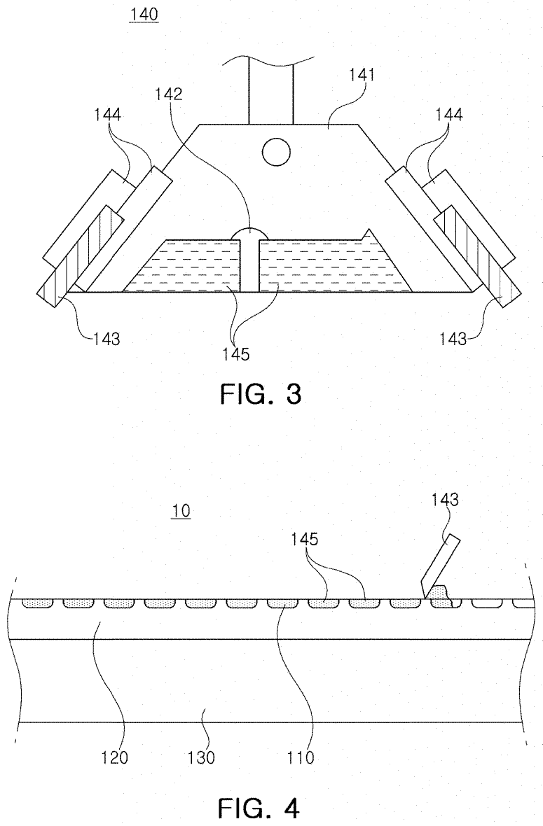

Referring to FIG. 3, a chamber doctor 140 according to an example of the present disclosure may include a body 141, a dispositional space 142 of the printing paste 145 provided in the body 141, a squeegee 143 provided on both sides of the body. In addition, if necessary, a squeegee holder 144 supporting the squeegee 143 maybe further included. The chamber doctor 140 having such a structure maybe a sealed chamber doctor. In this case, as described above, the printing paste 145 may be used from a low viscosity to a high viscosity.

The squeegee 143 may be a configuration to scrape a printing paste remaining on the surface of the gravure printing plate 120 to remove the printing paste remaining on the surface of the gravure printing plate 120, thereby filling a printing paste only inside the plurality of cells 110 of the gravure printing plate 120 formed by engraving. The specific shape or material of the squeegee 143 is not particularly limited, and a shape or material well known in the art may be applied.

The pressing roll 150 may press the sheet 101 to serve to contact the surface of a flat plate 202. The pressing roll 150 may be formed of a material having elasticity, and may be raised and lowered by a driving member 160. The pressing roll 150 may have a shape in which a diameter decreases from a central position in a longitudinal direction toward an edge, and in this case, the pressing roll 150 may be flatly deformed, such that the pressure applied to the sheet 101 may be uniform, but is not necessarily limited thereto, and may be made of another material or may have a shape having the same diameter.

A drying device 12 may use a device of a type generally used in the art, and may be integrated with a roll-to-roll device. For example, the drying device 12 may include a drying chamber, and in this case, drying may be performed in a chamber disconnected from the outside. In addition, nitrogen or argon maybe injected into the chamber, and internal pressure, or the like, may be appropriately adjusted.

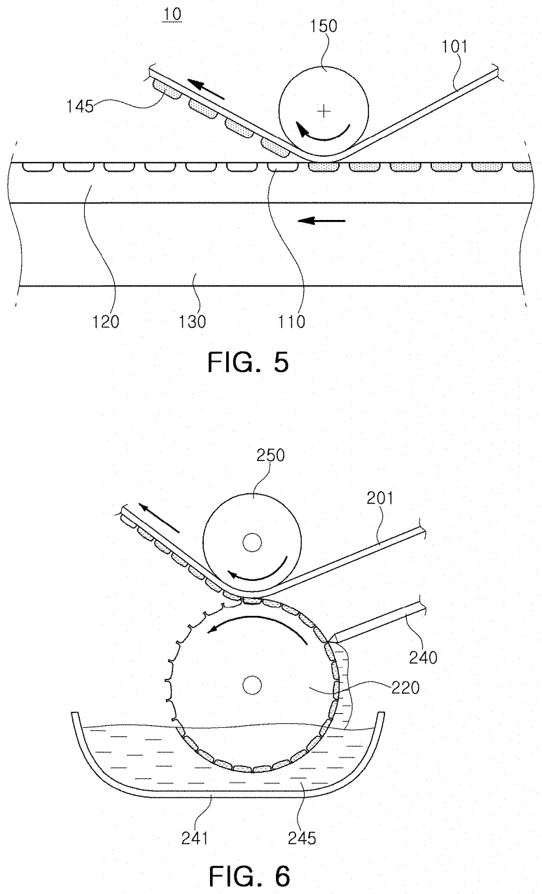

FIGS. 4 and 5 illustrate a schematic process sequence of a printing method using a gravure printing device according to the present embodiment. Referring to FIGS. 4 and 5, in the printing method using the gravure printing device according to the present disclosure, a step in which a printing paste 145 is applied to a surface of the gravure printing plate 120 using the chamber doctor 140, and the surface of the gravure printing plate 120 is scraped off using the squeegee 143 provided in the chamber doctor 140 to fill the printing paste may be included.

In addition, the printing method using the gravure printing device according to the present disclosure may include a step of transferring the filled printing paste. In the step of transferring the printing paste, the sheet 101 moving in a printing direction (arrow) may be pressed using the pressing roll 150 to be in contact with a plurality of cells 110 filled with the printing paste 145 of the gravure printing plate 120 moving in the printing direction (arrow).

The moving direction of the sheet 101 and the moving direction of the gravure printing plate 120 may be the same as in the printing direction, and the surfaces of the sheet 101 and the gravure printing plate 120 may be in contact with each other by the pressing roll 150 during the movement. In this case, a printing paste 145 of the gravure printing plate 120 may be directly transferred to the sheet 101.

The printing paste 145 may vary depending on an applied product. For example, when printing an internal electrode of a multilayer ceramic capacitor, the printing paste 145 may include a mixture of conductive powder, a resin, a solvent, and the like, but is not limited thereto.

As the conductive powder, various conductive metals such as silver (Ag), gold (Au), platinum (Pt), copper (Cu), aluminum (Al), nickel (Ni), and the like can be used. In this case, the metal may be an alloy. In addition, the metal may be formed by a method of coating another metal to particle grains of conductive powder. The particles may have various shapes such as spherical, dendrites and flakes.

Various resins, such as a thermosetting resin, an ultraviolet curable resin, a thermoplastic resin, can be used for a resin. The thermosetting resin may be, for example, a melamine resin, an epoxy resin, a phenol resin, a polyimide resin, an acrylic resin, and the like. The ultraviolet curable resin may be, for example, an acrylic resin which has a (meth) acryloyl group, an epoxy resin, a polyester resin, and a mixture thereof and a monomer. In addition, the thermosetting resin may be, for example, a polyester resin, a polyvinyl butyral resin, a cellulose resin, an acrylic resin and the like. These resins may be used alone or in combination of two or more thereof.

In order to prevent drying of the printing paste 145 in a printing process, it is preferable to contain a high boiling point solvent with a boiling point of 240° C. or more in the solvent. As such a high boiling point solvent, there may be, for example, diamyl benzene, triamyl benzene, diethylene glycol, diethylene glycol monobutyl ether acetate, diethylene glycol dibutyl ether, diethylene glycol monoacetate, triethylene glycol, triethylene glycol mono Methyl ether, triethylene glycol monoethyl ether, triethylene glycol monobutyl ether, tetraethylene glycol, tetraethylene glycol monobutyl ether, or the like. However, the present disclosure is not limited thereto, and a low boiling point solvent may also be used.

The sheet 101 may vary depending on the applied product. For example, the sheet 101 may be a dielectric sheet when printing the internal electrodes of the multilayer ceramic capacitor, but is not limited thereto.

The dielectric sheet may be formed of a ceramic powder having a high dielectric constant, and the ceramic powder may be, for example, barium titanate (BaTiO₃) based powder, strontium titanate (SrTiO₃) based powder, or the like, but is not limited thereto, and other known ceramic powders can be used. The dielectric sheet may be formed by applying and drying a slurry including the ceramic powder on a carrier film to prepare a plurality of ceramic green sheets. That is, although not specifically illustrated in the drawing, the sheet 101 may be formed on the carrier film.

FIG. 6 is a schematic diagram illustrating a gravure printing device according to another embodiment of the present disclosure. Referring to FIG. 6, a gravure printing device according to the present embodiment may include a gravure roll 220, a pressing roll 250, and a supply container 241. In this case, the gravure printing plate described above may be disposed on an outer circumferential surface of the gravure roll 220. A sheet 201 for printing may be disposed between the gravure roll 220 and the pressing roll 250, and the sheet 201 may be transported by rotation of the gravure roll 220 and the pressing roll 250. Details of the pressing roll, the sheet, the gravure printing plate, and the like, are the same as described above, and thus will be omitted.

A printing method using the gravure printing device according to the present embodiment may also include a step of filling a printing paste and a step of transferring the filled printing paste.

The gravure roll 220 is immersed in a printing paste 245, which is a printing medium accommodated in the supply container 241 for supplying the printing medium while rotating. While being immersed in the printing paste, the printing paste 245 may be filled inside a cell of the gravure printing plate disposed on the gravure roll 220, the cell of the gravure printing plate may be headed to the pressing roll 250 along the rotating gravure roll 220.

A doctor blade 240 may be disposed on the surface of the gravure roll 220 as necessary. The remaining printing media after filling the cell of the gravure printing plate may be scraped off by the doctor blade 240. The printing paste filled in the cell may be transferred to the sheet 101 at the point where the gravure roll 220 and the pressing roll 250 contact to each other.

As set forth above, according to an embodiment of the present disclosure, a gravure printing plate and a gravure printing device capable of improving printing roughness may be provided.

According to another embodiment of the present disclosure, a gravure printing plate and a gravure printing device capable of improving thickness distribution may be provided.

According to another embodiment of the present disclosure, a gravure printing plate and a gravure printing device capable of improving breakdown voltage (BDV) characteristics may be provided.

However, various and advantageous advantages and effects of the present disclosure are not limited to the above description, and will be more readily understood in the process of describing specific embodiments of the present disclosure.

While this disclosure includes specific examples, it will be apparent to one of ordinary skill in the art that various changes in form and details may be made in these examples without departing from the spirit and scope of the claims and their equivalents.

What is claimed is:

1. A gravure printing plate, comprising:
a convex portion and at least two polygonal cells partitioned by the convex portion, and
at least one protruding portion disposed at an edge of each of the at least two polygonal cells and extending toward a central portion thereof.

2. The gravure printing plate of claim 1, wherein the polygonal has a shape in which a plurality of convex portions form an angle of 180° or less.

3. The gravure printing plate of claim 1, wherein a height of the convex portion is in a range from 5 μm to 30 μm.

4. The gravure printing plate of claim 1, wherein when a longest distance from any one edge of a cell among the at least two polygonal cells passing through a center of the cell to a convex portion opposing the edge is a length (A) of a cell, a ratio (B/A) of a length (B) of the protruding portion to the length of the cell is 0.167 or more.

5. The gravure printing plate of claim 1, wherein the at least one protruding portion comprises two or more protruding portions disposed inside each of the at least two polygonal cells.

6. The gravure printing plate of claim 1, wherein the protruding portion is disposed at all edges inside each of the at least two polygonal cells.

7. The gravure printing plate of claim 1, wherein one side of the convex portion of each of the at least two polygonal cells is disposed to correspond to one side of a convex portion of an adjacent cell, and
the gravure printing plate further includes a passage disposed in the convex portion such that each of the at least two polygonal cells connected to the adjacent cell in a printing direction of the printing plate.

8. The gravure printing plate of claim 7, wherein a width of the passage is in a range of 10 μm to 20 μm.

9. A gravure printing device, comprising:
the gravure printing plate of claim 1;
a chamber doctor applying a printing paste to a surface of the gravure printing plate to fill the at least two polygonal cells with the printing paste; and
a pressing roll pressing a sheet provided to the gravure printing plate in a roll-to-roll manner to contact the sheet to the at least two polygonal cells filled with the printing paste.

10. The gravure printing device of claim 9, wherein the chamber doctor comprises a body, a dispositional space of the printing paste provided in the body, and a squeegee provided on both sides of the body.

11. A gravure printing device, comprising:
a gravure roll having the gravure printing plate of claim 1 disposed on an outer circumferential surface thereof;
a supply container positioned such that a portion of the gravure roll is immersed, and to which a printing medium is supplied to the cell of the gravure printing plate when the gravure roll rotates; and
a pressing roll having a sheet for printing with the gravure roll therebetween and rotating by contacting a portion thereof, and moving the sheet for printing according to the rotation.

12. The gravure printing device of claim 11, wherein a doctor blade disposed on the surface of the gravure roll is included.

13. A gravure printing plate, comprising:
at least two polygonal wells spaced apart from each other, each well having a bottom; and
at least one ridge disposed at the bottom of each well, and extending from an edge thereof toward a central portion thereof.

14. The gravure printing plate of claim 13, wherein a depth of each of the at least two wells is in a range from 5 μm to 30 μm.

15. The gravure printing plate of claim 14, wherein a height of the at least one ridge is less than or equal to the depth of the corresponding well.

16. The gravure printing plate of claim 13, wherein a ratio B/A of a length B of the ridge disposed in a well to a largest dimension A of that well to greater than or equal to 0.167.

17. The gravure printing plate of claim 13, wherein the each of the at least two wells is disposed to have one edge thereof to be adjacent to an adjacent well,
wherein the gravure printing plate further includes a passage well connecting adjacent edges of adjacent wells.
